(19) United States
(12) Patent Application Publication
(10) Pub. No.: US 2022/0335270 A1
(43) Pub. Date: Oct. 20, 2022

(54) KNOWLEDGE GRAPH COMPRESSION

(71) Applicant: International Business Machines Corporation, Armonk, NY (US)

(72) Inventors: Tengfei Ma, White Plains, NY (US); Manling Li, Urbana, IL (US); Mo Yu, White Plains, NY (US); Tian GAO, Berkeley Heights, NJ (US); LINGFEI WU, Elmsford, NY (US)

(21) Appl. No.: 17/231,289

(22) Filed: Apr. 15, 2021

(51) Int. Cl. G06N 3/04

(52) U.S. Cl. CPC G06N 3/04

(57) ABSTRACT

Aspects of the present disclosure relate to knowledge graph compression. An input knowledge graph (KG) can be received. The input KG can be encoded to receive a first set of node embeddings. The input KG can be compressed into an output KG. The output KG can be encoded to receive a second set of node embeddings. A model for KG compression can be trained using optimal transport based on a distance matrix between the first set of node embeddings and the second set of node embeddings.

### BACKGROUND

The present disclosure relates generally to the field of computing, and in particular, to knowledge graph compression.

Knowledge graphs (KGs) are graph structures that represent data. In particular, KGs are digital structures mapping a network of entities (e.g., objects, concepts, etc.) and their semantic types, properties (e.g., attributes), and relationships (hierarchical and relational). KGs are widely implemented in search engines, question/answer (Q/A) services, social networks, and other natural language based tasks.

A KG can be comprised of nodes (e.g., vertices) and edges interconnecting the nodes. The nodes of the knowledge graph are often called “entities,” and edges between two entities are often referenced by “triplets,” represented by a tuple (e₁, r, e₂), where e₁ is a first entity, e₂ is a second entity, and r is a relation between the two entities. Building a KG structure can be completed by appending entities and relations to the KG based on an available knowledge corpus (e.g., semantic information within the knowledge corpus).

As a KG structure grows larger, it can be computationally intensive if used as-is. This is because the KG may include redundant, irrelevant, and/or extraneous nodes and/or edges. For example, information present within the KG may be unrelated to the task at hand, and may require additional computing time to traverse extraneous information within the KG to obtain a response (e.g., an answer to a query).

### SUMMARY

Embodiments of the present disclosure include a method for knowledge graph compression. According to the method, an input knowledge graph (KG) can be received. The input KG can be encoded to receive a first set of node embeddings. The input KG can be compressed into an output KG. The output KG can be encoded to receive a second set of node embeddings. A model for KG compression can be trained using optimal transport based on a distance matrix between the first set of node embeddings and the second set of node embeddings.

The above method provides several advantages. By encoding the input and output KGs, both node features and the global graph topology can be captured and encoded. This enhances the reliability and accuracy of the model trained on the KG compression. Further, by using optimal transport to train the model, the semantic distance between two graphs is more accurately captured, leading to less semantic information loss during training.

Embodiments of the present disclosure also relate to a system comprising one or more processors and one or more computer-readable storage media collectively storing program instructions which, when executed by the one or more processors, are configured to cause the one or more processors to perform a method. According to the method, an input knowledge graph (KG) can be received. The input KG can be encoded to receive a first set of node embeddings. The input KG can be compressed into an output KG. The output KG can be encoded to receive a second set of node embeddings. A model for KG compression can be trained using optimal transport based on a distance matrix between the first set of node embeddings and the second set of node embeddings.

The above system provides several advantages. By encoding the input and output KGs, both node features and the global graph topology can be captured and encoded. This enhances the reliability and accuracy of the model trained on the KG compression. Further, by using optimal transport to train the model, the semantic distance between two graphs is more accurately captured, leading to less semantic information loss during training.

Embodiments of the present disclosure also relate to a computer program product comprising one or more computer readable storage media, and program instructions collectively stored on the one or more computer readable storage media, the program instructions comprising instructions configured to cause one or more processors to perform a method. According to the method, an input knowledge graph (KG) can be received. The input KG can be encoded to receive a first set of node embeddings. The input KG can be compressed into an output KG. The output KG can be encoded to receive a second set of node embeddings. A model for KG compression can be trained using optimal transport based on a distance matrix between the first set of node embeddings and the second set of node embeddings.

The above computer program product provides several advantages. By encoding the input and output KGs, both node features and the global graph topology can be captured and encoded. This enhances the reliability and accuracy of the model trained on the KG compression. Further, by using optimal transport to train the model, the semantic distance between two graphs is more accurately captured, leading to less semantic information loss during training.

The above summary is not intended to describe each illustrated embodiment or every implementation of the present disclosure.

### BRIEF DESCRIPTION OF THE DRAWINGS

The drawings included in the present disclosure are incorporated into, and form part of, the specification. They illustrate embodiments of the present disclosure and, along with the description, serve to explain the principles of the disclosure. The drawings are only illustrative of typical embodiments and do not limit the disclosure.

FIG. 1 is a block diagram illustrating an example computing environment in which illustrative embodiments of the present disclosure can be implemented.

FIG. 2 is a diagram illustrating a process for training a model for KG compression, in accordance with embodiments of the present disclosure.

FIG. 3 is a flow-diagram illustrating an example method for training a model for KG compression, in accordance with embodiments of the present disclosure.

FIG. 4 is a diagram illustrating a cloud computing environment, in accordance with embodiments of the present disclosure.

FIG. 5 is a block diagram illustrating abstraction model layers, in accordance with embodiments of the present disclosure.

FIG. 6 is a high-level block diagram illustrating an example computer system that may be used in implementing one or more of the methods, tools, and modules, and any related functions, described herein, in accordance with embodiments of the present disclosure.

While the embodiments described herein are amenable to various modifications and alternative forms, specifics thereof have been shown by way of example in the drawings and will be described in detail. It should be understood, however, that the particular embodiments described are not to be taken in a limiting sense. On the contrary, the intention is to cover all modifications, equivalents, and alternatives falling within the spirit and scope of the disclosure.

### DETAILED DESCRIPTION

Aspects of the present disclosure relate generally to the field of computing, and in particular, to knowledge graph compression. While the present disclosure is not necessarily limited to such applications, various aspects of the disclosure can be appreciated through a discussion of various examples using this context.

Knowledge graphs (KGs) are graph structures that represent data. In particular, KGs are a digital structure mapping a network of entities (e.g., objects, concepts, etc.) and their semantic types, properties (e.g., attributes), and relationships (hierarchical and relational). KGs are widely implemented in search engines, question/answer (Q/A) services, social networks, and other natural language based tasks. Because KGs formally represent semantics by describing entities and their associated relationships, logical inference for retrieving implicit knowledge is possible (rather than only allowing queries requesting explicit knowledge).

A KG can be comprised of nodes (e.g., vertices) and edges interconnecting the nodes. The nodes of the knowledge graph are often called “entities,” and edges between two entities are often referenced by “triplets,” represented by a tuple (e₁, r, e₂), where e₁ is a first entity, e₂ is a second entity, and r is a relation between the two entities. Building a KG structure can be completed by appending entities and relations to the KG based on an available knowledge corpus (e.g., semantic information within the knowledge corpus).

As a KG structure grows larger, it can be computationally intensive if used as-is. This is because the KG may include redundant, irrelevant, and/or extraneous nodes and/or edges. For example, information present within the KG may be unrelated to the task at hand, and may require additional computing time to traverse extraneous information within the KG to obtain a response (e.g., an answer to a query). Thus, compression of KGs may be desired to enhance computational gains. Solutions for compressing KGs to improve information retrieval by reducing computational load are needed.

Aspects of the present disclosure relate to knowledge graph compression. An input knowledge graph (KG) can be received. The input KG can be encoded to receive a first set of node embeddings. The input KG can be compressed into an output KG. The output KG can be encoded to receive a second set of node embeddings. A model for KG compression can be trained using optimal transport based on a distance matrix between the first set of node embeddings and the second set of node embeddings.

Aspects of the present disclosure provide several advantages. By encoding the input and output KG using graph neural networks or other embedding techniques, both node features and the global graph topology can be captured and encoded. This enhances the reliability and accuracy of the model trained on the KG compression. Further, by using optimal transport as an objective function, the semantic distance between two graphs is more accurately captured, leading to less semantic information loss during training. Aspects of the present disclosure allow for the automatic compression of (large) knowledge graphs based on a trained model, which may improve accuracy, processing speed, and information retrieval associated with a predefined knowledge graph.

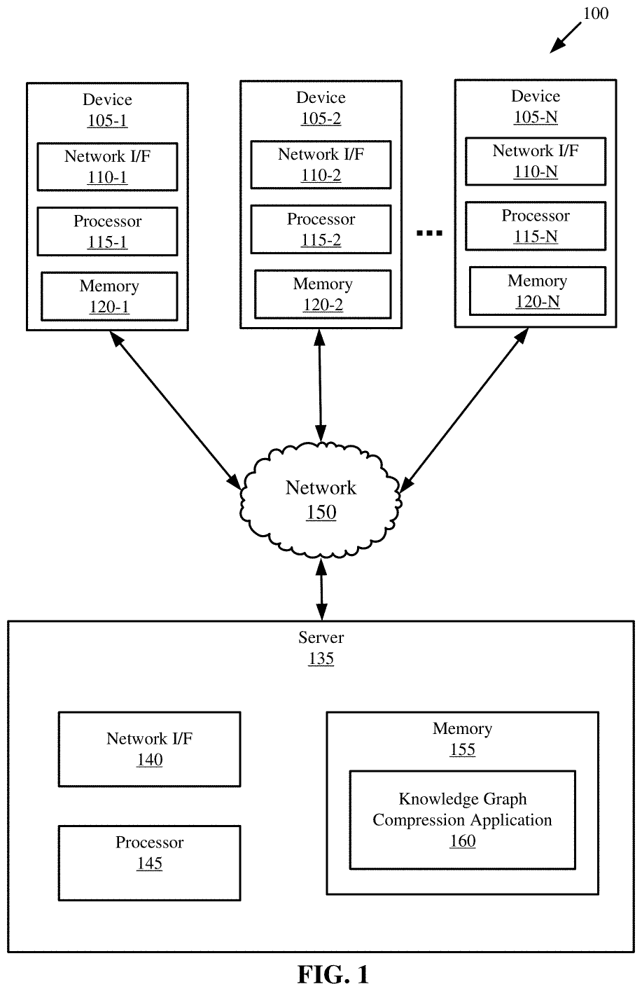

Turning now to the figures, FIG. 1 is a block diagram illustrating an example computing environment 100 in which illustrative embodiments of the present disclosure can be implemented. Computing environment 100 includes a plurality of devices 105-1, 105-2 . . . 105-N (collectively devices 105), at least one server 135, and a network 150.

The devices 105 and the server 135 include one or more processors 115-1, 115-2 . . . 115-N (collectively processors 115) and 145 and one or more memories 120-1, 120-2 . . . 120-N (collectively memories 120) and 155, respectively. The devices 105 and the server 135 can be configured to communicate with each other through internal or external network interfaces 110-1, 110-2 . . . 110-N (collectively network interfaces 110) and 140. The network interfaces 110 and 140 are, in some embodiments, modems or network interface cards. The devices 105 and/or the server 135 can be equipped with a display or monitor. Additionally, the devices 105 and/or the server 135 can include optional input devices (e.g., a keyboard, mouse, scanner, a biometric scanner, video camera, or other input device), and/or any commercially available or custom software (e.g., browser software, communications software, server software, natural language processing software, search engine and/or web crawling software, image processing software, etc.).

The devices 105 and the server 135 can be distant from each other and communicate over a network 150. In some embodiments, the server 135 can be a central hub from which devices 105 can establish a communication connection, such as in a client-server networking model. Alternatively, the server 135 and devices 105 can be configured in any other suitable networking relationship (e.g., in a peer-to-peer (P2P) configuration or using any other network topology).

In some embodiments, the network 150 can be implemented using any number of any suitable communications media. For example, the network 150 can be a wide area network (WAN), a local area network (LAN), an internet, or an intranet. In certain embodiments, the devices 105 and the server 135 can be local to each other and communicate via any appropriate local communication medium. For example, the devices 105 and the server 135 can communicate using a local area network (LAN), one or more hardwire connections, a wireless link or router, or an intranet. In some embodiments, the devices 105 and the server 135 can be communicatively coupled using a combination of one or more networks and/or one or more local connections. For example, the first device 105-1 can be hardwired to the server 135 (e.g., connected with an Ethernet cable) while the second device 105-2 can communicate with the server 135 using the network 150 (e.g., over the Internet).

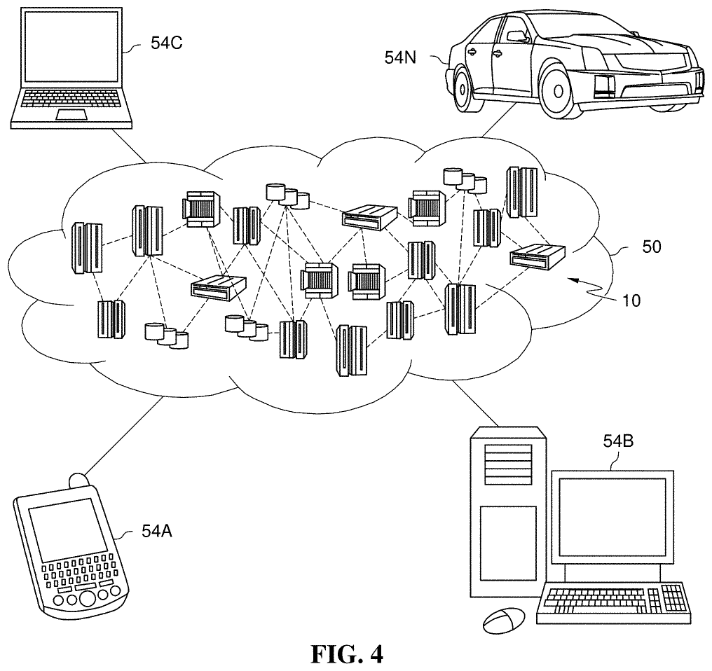

In some embodiments, the network 150 is implemented within a cloud computing environment or using one or more cloud computing services. Consistent with various embodiments, a cloud computing environment can include a network-based, distributed data processing system that provides one or more cloud computing services. Further, a cloud computing environment can include many computers (e.g., hundreds or thousands of computers or more) disposed within one or more data centers and configured to share resources over the network 150. In some embodiments, the network 150 may be substantially similar to, or the same as, cloud computing environment 50 described in FIG. 4.

The server 135 includes a knowledge graph (KG) compression application 160. The KG compression application 160 can be configured to train a model (e.g., an unsupervised machine learning model) to compress an input knowledge graph into a compressed output knowledge graph. The KG compression application 160 can then be configured to use the model to compress input knowledge graphs into compressed output knowledge graphs using the trained model.

The KG compression application 160 can first be configured to receive an input KG. The input KG can be generated and/or received in any suitable manner. For example, an input KG can be generated using natural language processing (NLP) and/or ontology based analyses such that textual data (or audio/image data) within a given knowledge corpus (e.g., domain) can be classified (e.g., via semantic analysis, tokenization, etc.) and relationships can be extracted therefrom. Building a knowledge graph can include domain terminology extraction, named entity recognition (NER), concept discovery, concept hierarchy derivation, learning of non-taxonomic relations, rule discovery, concept hierarchy extension, and frame and event detection, among others. Each of these methodologies may integrate one or more machine learning and/or NLP based analyses.

Upon receiving the input KG, the input KG is encoded. Encoding a KG generally refers to converting the KG into a form suitable for analysis. Encoding the KG is completed such that processing of the KG using, for example, machine learning models can be completed. Encoding the KG can be completed due to the complex nature of knowledge graphs (e.g., structured within a Non-Euclidean space), which may be simplified using methods which automatically learn to encode graph structures into low-dimensional embeddings. In embodiments, a graph convolutional network (GCN) is implemented to encode the graph structure. In embodiments, a relational graph convolutional network (R-GCN) is implemented to encode the KG. This can yield node and/or edge embeddings capturing the input KG structure. However, methods for encoding the input KG are merely exemplary, and any suitable other method for encoding the input KG can be utilized (e.g., TransE, RotatE, CompGCN, etc.).

The KG compression application 160 then compresses the input KG. Compressing the input KG can include sparsification (e.g., removing edges) and/or coarsening (e.g., removing/combining vertices) of the input KG. In embodiments, coarsening can include applying a graph coarsening model which is trained to select top ranked nodes (e.g., vertices) used to form a compressed output KG. In embodiments, compression of the input KG can utilize algebraic multigrid (AMG) for selecting top ranked nodes to be included in the compressed output graph. In some embodiments, Attention Based Top-K Pooling can be utilized to select top ranked nodes to be integrated into the compressed output KG. In some embodiments, meta information such as a query input can be considered such that the compressed output KG can be focused on the meta information (e.g., query-focused). However, any suitable differentiable method for compressing the input KG into the output KG can be implemented (e.g., SAGPool, StructPool, etc.). Ultimately, the compression of the input KG into the output KG can be used as training data such that an unsupervised machine learning model (e.g., a deep neural network) based on optimal transport can automatically compress the input KG.

Upon compressing the input KG into the output KG, the output KG is encoded, for example, using the same, or substantially similar methods, for encoding the input KG. As an example, the output KG can also be encoded using an R-GCN. As such, a set of node and/or edge embeddings can be received as an output of the encoding of the output KG. However, any suitable method for encoding the output KG can be implemented. In embodiments, the method for encoding the input KG can mirror the method for encoding the output KG.

Upon receiving sets of node and/or edge embeddings for each of the input KG and the output KG, the KG compression application 160 can be configured to train an unsupervised machine learning model based on optimal transport for a distance matrix [M] between the node and/or edge embeddings. Optimal transport generally refers to applying transportation theory to optimally (e.g., with minimal cost) transport an initial distribution to a target distribution. In context of the disclosure, optimal transport refers to optimally (e.g., with minimal cost) converting the input KG into the output KG. Thus, the distance between the node and/or edge embeddings can be captured in a distance matrix [M]. As a part of training the machine learning model, a Wasserstein distance (e.g., Wasserstein metric), Wγ, can be minimized. In particular, Wasserstein distance can be minimized using Sinkhorn's algorithm to approximate the entropy regularized Wasserstein distance and make it differentiable, per Equation (1), presented below.

$${W}_{γ} ( G , {G}_{c} ) := {min}_{P ϵ U ( a , b )} 〈 P , M 〉 - γ E ( P ) \qquad Equation ( 1 )$$

According to Equation (1), the element of [M], Mᵢⱼ, indicates the pairwise distance between node i and node j; P is the transportation plan between the two set of nodes; and E(P) is the entropy. Using Equation 1, deep neural network based unsupervised learning system can be constructed with KGs as inputs and the above regularized Wasserstein distance as a loss function. This objective function is optimized by gradient descent based methods to train all the parameters for KG embedding (e.g., R-GCN) and graph compression.

Training of the unsupervised machine learning model can be executed until a satisfactory amount of training is completed. For example, training can be completed until a particular performance metric is met (e.g., a ROGUE_1 score, ROGUE_2 score, a ROGUE_L score, a statistical informativeness and/or relatedness metric, etc.), until a particular time period lapses, until a particular number of cycles are completed, and/or until a particular amount of resources (e.g., memory and/or processor utilization) are consumed.

Upon training the unsupervised machine learning algorithm to compress KGs based on optimal transport, additional KGs can be compressed using the unsupervised machine learning algorithm. Thus, KGs can be automatically compressed into compressed output KGs using the trained machine learning model.

It is noted that FIG. 1 is intended to depict the representative major components of an example computing environment 100. In some embodiments, however, individual components can have greater or lesser complexity than as represented in FIG. 1, components other than or in addition to those shown in FIG. 1 can be present, and the number, type, and configuration of such components can vary.

While FIG. 1 illustrates a computing environment 100 with a single server 135, suitable computing environments for implementing embodiments of this disclosure can include any number of servers. The various models, modules, systems, and components illustrated in FIG. 1 can exist, if at all, across a plurality of servers and devices. For example, some embodiments can include two servers. The two servers can be communicatively coupled using any suitable communications connection (e.g., using a WAN, a LAN, a wired connection, an intranet, or the Internet).

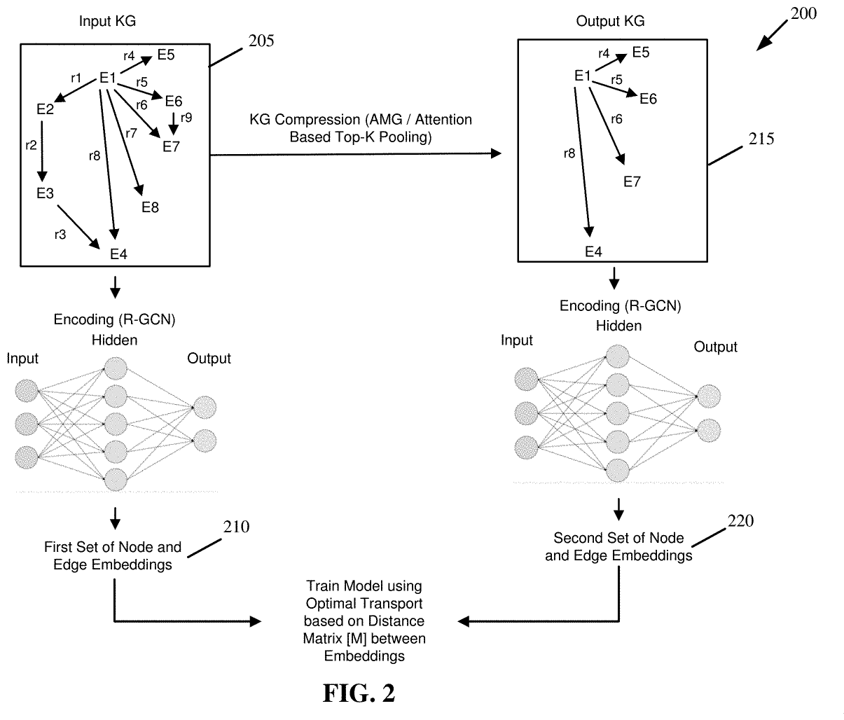

Referring now to FIG. 2, shown is a diagram 200 illustrating a process for training a machine learning model (e.g., an unsupervised model) to compress knowledge graphs, in accordance with embodiments of the present disclosure.

An input KG 205 can first be received and/or generated. As discussed with reference to FIG. 1, any suitable method for generating the input KG 205 can be completed (e.g., using machine learning, natural language processing, and/or ontological based analyses). As shown in FIG. 2, the input KG 205 includes several entities E1-E8, and several relationships r1-r9 between the entities.

The input KG 205 is then encoded, using, for example, an R-GCN. Encoding a knowledge graph generally refers to converting the KG into a form suitable for analysis. In the context of the present disclosure, encoding a KG can refer to generating node and/or edge embeddings (e.g., vectors) based on the input KG 205 structure. For example, a first node (E1) can have a first embedding, a second node (E2) can have a second embedding, a third node (E3) can have a third embedding, etc. Similarly, a first edge (r1) can have a first embedding, a second edge (r2) can have a second embedding, a third edge (r3) can have a third embedding, etc. As such, a first set of node and/or edge embeddings 210 are received in response to encoding the input KG 205. Though reference is made to encoding the input KG 205 using an R-GCN, any other suitable method for encoding the input KG 205 can be implemented.

The input KG 205 can then be compressed into an output KG 215. Compression of the input KG 205 into the output KG 215 can be completed using methods for sparsification and/or coarsening. In embodiments, coarsening can include applying a graph coarsening model which is trained to select top ranked nodes (e.g., vertices) used to form compressed output KG 215. In embodiments, compression of the input KG 205 can utilize algebraic multigrid (AMG) for selecting top ranked nodes to be included in the compressed output KG 215. In some embodiments, Attention Based Top-K Pooling can be utilized to select top ranked nodes to be integrated into the compressed output KG 215. In some embodiments, meta information, such as a query input, can be considered such that the compressed output KG 215 can be focused on the meta information (e.g., query-focused). However, any suitable method for compressing the input KG into the output KG can be completed.

As shown in FIG. 2, the output KG 215 only includes a subset of the entities that the input KG 205 includes (e.g., E1, E3, E5, E6, and E7). Further, the output KG 215 only includes a subset of the relations that the input KG 205 includes (e.g., r4, r5, r6, and r8). Thus, the output KG 215 is a compressed form of the input KG 205, omitting certain nodes and/or edges from the input KG 205. The KG compression depicted in FIG. 2 is merely exemplary, and any suitable number of nodes and/or edges can be removed and/or combined from the input KG 205 based on an applied compression model.

The output KG 215 can then be encoded, using, for example, the same, or a substantially similar manner, as described with respect to the input KG 205. As shown in FIG. 2, encoding the output KG 215 can include applying an R-GCN. As such, a second set of node and/or edge embeddings 220 can be received in response to encoding the input KG 205.

Thereafter, a model (e.g., an unsupervised machine learning model) can be trained using optimal transport based on a distance matrix, M, between the first set of node and edge embeddings 210 and the second set of node and edge embeddings 220. As discussed with reference to FIG. 1, the model can be trained to minimize a Wasserstein distance of the distance matrix, M, (e.g., using Sinkhorn's algorithm to approximate the entropy regularized Wasserstein distance and make it differentiable), per Equation (1), referenced above. Optimal transport generally refers to applying transportation theory to optimally (e.g., with a minimal cost, a sufficiently reduced cost, etc.) transport an initial distribution to a target distribution. In context of the disclosure, optimal transport refers to optimally (e.g., with minimal cost or sufficiently reduced cost) converting the input KG 205 into the output KG 215.

The model can be trained until sufficient training is completed. In embodiments, this can be based on a time metric, a cycle metric (e.g., the number of compression cycles that are learned), a performance metric, and/or a resource utilization metric. Upon sufficiently training the machine learning model, additional KGs can be received and compressed using the trained model.

The trained model can be used in various applications. A first example includes receiving an input knowledge graph with sentences and words as nodes (e.g., entities) within the knowledge graph, and term frequency-inverse document frequency (tf-idf) values as edges between pairs of sentence-word nodes. In this example, by applying the trained model, the input KG can be compressed into an output KG. In this instance, the output KG may be an extractive summary of the input KG, where the most relevant (e.g., based on the KG compression model) sentences/words are presented to a user.

A second example includes receiving an input KG from an online encyclopedia (e.g., Wikipedia®), where hyperlinks are defined as entities within the KG and relations are captured within metadata (e.g., Wikidata). In this example, the input KG can be based on the main page of a given entity. The input KG can then be compressed using the trained model to obtain an output KG including the most relevant entities and/or relations. This may serve as a summary of the main page.

A third example includes receiving an input KG generated based on news articles of recent events extracted by an information extraction system. The input KG may include a plethora of individuals, dates, times, locations, etc. as entities, with defined relationships among the entities scattered throughout the news articles. In this example, the trained model can compress the input KG such that a corresponding timeline of events can be received. The timeline may include only relevant/important individuals, locations, and time periods based on training of the compression model.

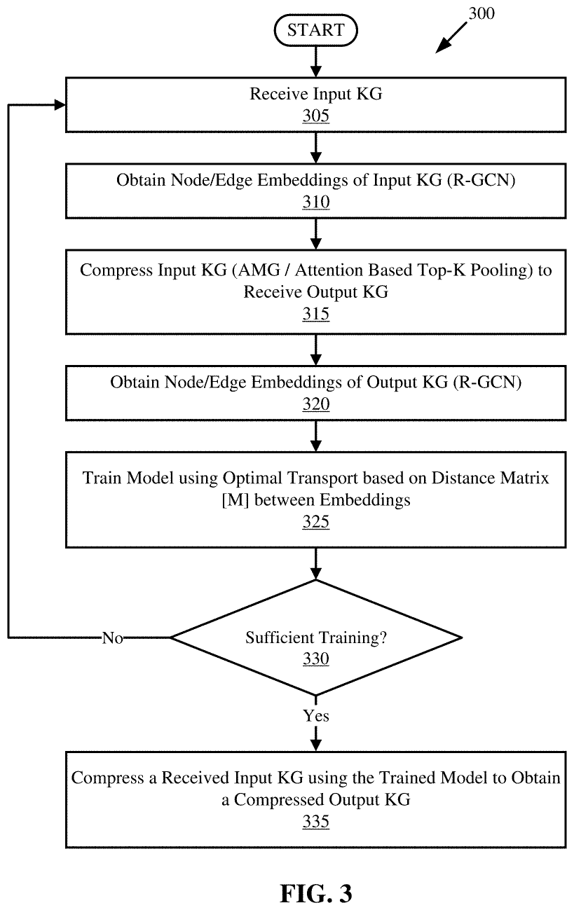

Referring now to FIG. 3, shown is a flow diagram of an example method 300 for training a model for knowledge graph compression, in accordance with embodiments of the present disclosure. One or more operations of method 300 can be completed by one or more processing circuits (e.g., devices 105 and server 135)

Method 300 initiates at operation 305, where an input KG is received. The input KG can be received and/or generated in any suitable manner. In some embodiments, the input KG can be a large KG covering a particular domain which has not been refined. In embodiments, the input KG can be generated using machine learning based, NLP based, and/or ontological based analyses on a data corpus.

A first set of node and/or edge embeddings are obtained from the input KG. This is illustrated at operation 310. Obtaining node and/or edge embeddings can be completed by encoding the input KG structure using, for example, machine learning models, such as a relational graph convolutional network (R-GCN).

The input KG is then compressed to receive an output KG. This is illustrated at operation 315. Compression can include applying methods for sparsification and coarsening of the input KG. In embodiments, coarsening can include applying a graph coarsening model which is trained to select top ranked nodes (e.g., vertices) used to form compressed output KG (e.g., algebraic multigrid (AMG) and Attention Based Top-K Pooling).

A second set of node and/or edge embeddings are obtained from the output KG. This is illustrated at operation 320. Obtaining node and/or edge embeddings from the output KG can be completed in the same, or a substantially similar manner, as described with respect to operation 310.

A model (e.g., an unsupervised machine learning model) can be trained using optimal transport based on a distance matrix, M, between the first set of node and/or edge embeddings received at operation 310 and the second set of node and/or edge embeddings received at operation 320. This is illustrated at operation 325. In embodiments, the model can be trained to minimize a Wasserstein distance of the distance matrix, M, (e.g., using Sinkhorn's algorithm to approximate the entropy regularized Wasserstein distance and make it differentiable), per Equation (1), referenced above.

A determination is then made whether there is sufficient training for the model. This is illustrated at operation 330. In embodiments, determining whether there is sufficient training can be completed based on comparison to one or more thresholds based on training time, training cycles, resource utilization, and/or performance metrics (e.g., ROGUE scores). However, any other suitable method for determining whether training is sufficient can be executed. For example, in some embodiments, determining whether training is sufficient can be completed based on a manual analysis of compressed output KGs.

If a determination is made that sufficient training is not completed, then method 300 returns to operation 305, where another input KG is received. Thus, another cycle of KG compression learning can be completed (e.g., between operations 305-325) to attempt to enhance the accuracy and reliability of the model.

If a determination is made that sufficient training is completed, then method 300 proceeds to operation 335, where a received input KG is compressed using the trained model to obtain a compressed output KG. Thus, the model can be applied to automatically compress input KGs into compressed output KGs.

The aforementioned operations can be completed in any order and are not limited to those described. Additionally, some, all, or none of the aforementioned operations can be completed, while still remaining within the spirit and scope of the present disclosure.

It is to be understood that although this disclosure includes a detailed description on cloud computing, implementation of the teachings recited herein are not limited to a cloud computing environment. Rather, embodiments of the present disclosure are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and personal digital assistants (PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

Referring now to FIG. 4, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A (e.g., devices 105), desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 4 are intended to be illustrative only and that computing nodes 10 and cloud computing environment 50 can communicate with any type of computerized device over any type of network and/or network addressable connection (e.g., using a web browser).

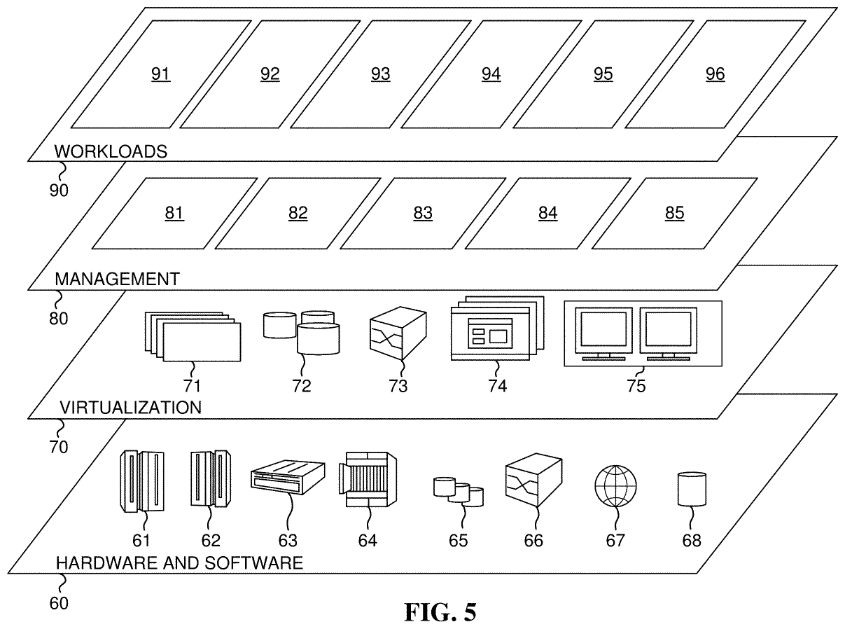

Referring now to FIG. 5, a set of functional abstraction layers provided by cloud computing environment 50 (FIG. 4) is shown. It should be understood in advance that the components, layers, and functions shown in FIG. 5 are intended to be illustrative only and embodiments of the disclosure are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and knowledge graph compression 96.

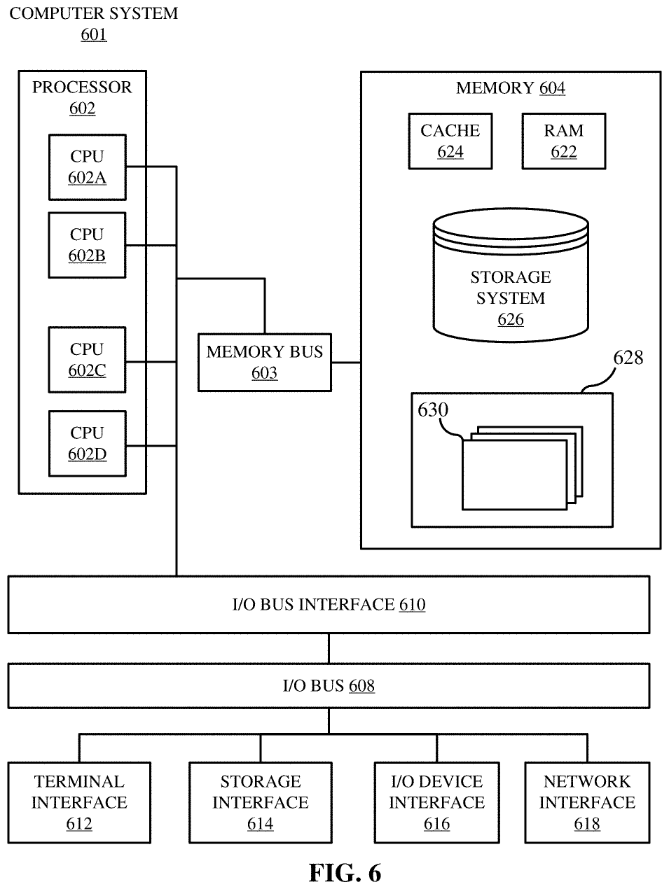

Referring now to FIG. 6, shown is a high-level block diagram of an example computer system 601 (e.g., devices 105 and server 135) that may be used in implementing one or more of the methods, tools, and modules, and any related functions, described herein (e.g., using one or more processor circuits or computer processors of the computer), in accordance with embodiments of the present disclosure. In some embodiments, the major components of the computer system 601 may comprise one or more CPUs 602, a memory subsystem 604, a terminal interface 612, a storage interface 614, an I/O (Input/Output) device interface 616, and a network interface 618, all of which may be communicatively coupled, directly or indirectly, for inter-component communication via a memory bus 603, an I/O bus 608, and an I/O bus interface unit 610.

The computer system 601 may contain one or more general-purpose programmable central processing units (CPUs) 602A, 602B, 602C, and 602D, herein generically referred to as the CPU 602. In some embodiments, the computer system 601 may contain multiple processors typical of a relatively large system; however, in other embodiments the computer system 601 may alternatively be a single CPU system. Each CPU 602 may execute instructions stored in the memory subsystem 604 and may include one or more levels of on-board cache.

System memory 604 may include computer system readable media in the form of volatile memory, such as random access memory (RAM) 622 or cache memory 624. Computer system 601 may further include other removable/non-removable, volatile/non-volatile computer system storage media. By way of example only, storage system 626 can be provided for reading from and writing to a non-removable, non-volatile magnetic media, such as a “hard-drive.” Although not shown, a magnetic disk drive for reading from and writing to a removable, non-volatile magnetic disk (e.g., a “floppy disk”), or an optical disk drive for reading from or writing to a removable, non-volatile optical disc such as a CD-ROM, DVD-ROM or other optical media can be provided. In addition, memory 604 can include flash memory, e.g., a flash memory stick drive or a flash drive. Memory devices can be connected to memory bus 603 by one or more data media interfaces. The memory 604 may include at least one program product having a set (e.g., at least one) of program modules that are configured to carry out the functions of various embodiments.

One or more programs/utilities 628, each having at least one set of program modules 630 may be stored in memory 604. The programs/utilities 628 may include a hypervisor (also referred to as a virtual machine monitor), one or more operating systems, one or more application programs, other program modules, and program data. Each of the operating systems, one or more application programs, other program modules, and program data or some combination thereof, may include an implementation of a networking environment. Programs 628 and/or program modules 630 generally perform the functions or methodologies of various embodiments.

Although the memory bus 603 is shown in FIG. 6 as a single bus structure providing a direct communication path among the CPUs 602, the memory subsystem 604, and the I/O bus interface 610, the memory bus 603 may, in some embodiments, include multiple different buses or communication paths, which may be arranged in any of various forms, such as point-to-point links in hierarchical, star or web configurations, multiple hierarchical buses, parallel and redundant paths, or any other appropriate type of configuration. Furthermore, while the I/O bus interface 610 and the I/O bus 608 are shown as single respective units, the computer system 601 may, in some embodiments, contain multiple I/O bus interface units 610, multiple I/O buses 608, or both. Further, while multiple I/O interface units are shown, which separate the I/O bus 608 from various communications paths running to the various I/O devices, in other embodiments some or all of the I/O devices may be connected directly to one or more system I/O buses.

In some embodiments, the computer system 601 may be a multi-user mainframe computer system, a single-user system, or a server computer or similar device that has little or no direct user interface, but receives requests from other computer systems (clients). Further, in some embodiments, the computer system 601 may be implemented as a desktop computer, portable computer, laptop or notebook computer, tablet computer, pocket computer, telephone, smart phone, network switches or routers, or any other appropriate type of electronic device.

It is noted that FIG. 6 is intended to depict the representative major components of an exemplary computer system 601. In some embodiments, however, individual components may have greater or lesser complexity than as represented in FIG. 6, components other than or in addition to those shown in FIG. 6 may be present, and the number, type, and configuration of such components may vary.

As discussed in more detail herein, it is contemplated that some or all of the operations of some of the embodiments of methods described herein can be performed in alternative orders or may not be performed at all; furthermore, multiple operations can occur at the same time or as an internal part of a larger process.

The present disclosure can be a system, a method, and/or a computer program product. The computer program product can include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network can comprise copper transmission cables, optical transmission fibers, wireless transmission, routers, firewalls, switches, gateway computers, and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure can be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions can execute entirely on the user's computer, partly on the user's computer, as a stand-alone software package, partly on the user's computer and partly on a remote computer or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions can be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions can also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions can also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams can represent a module, segment, or portion of instructions, which comprises one or more executable instructions for implementing the specified logical function(s). In some alternative implementations, the functions noted in the block can occur out of the order noted in the figures. For example, two blocks shown in succession can, in fact, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the various embodiments. As used herein, the singular forms “a,” “an,” and “the” are intended to include the plural forms as well, unless the context clearly indicates otherwise. It will be further understood that the terms “includes” and/or “including,” when used in this specification, specify the presence of the stated features, integers, steps, operations, elements, and/or components, but do not preclude the presence or addition of one or more other features, integers, steps, operations, elements, components, and/or groups thereof. In the previous detailed description of example embodiments of the various embodiments, reference was made to the accompanying drawings (where like numbers represent like elements), which form a part hereof, and in which is shown by way of illustration specific example embodiments in which the various embodiments can be practiced. These embodiments were described in sufficient detail to enable those skilled in the art to practice the embodiments, but other embodiments can be used and logical, mechanical, electrical, and other changes can be made without departing from the scope of the various embodiments. In the previous description, numerous specific details were set forth to provide a thorough understanding the various embodiments. But, the various embodiments can be practiced without these specific details. In other instances, well-known circuits, structures, and techniques have not been shown in detail in order not to obscure embodiments.

Different instances of the word “embodiment” as used within this specification do not necessarily refer to the same embodiment, but they can. Any data and data structures illustrated or described herein are examples only, and in other embodiments, different amounts of data, types of data, fields, numbers and types of fields, field names, numbers and types of rows, records, entries, or organizations of data can be used. In addition, any data can be combined with logic, so that a separate data structure may not be necessary. The previous detailed description is, therefore, not to be taken in a limiting sense.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Although the present disclosure has been described in terms of specific embodiments, it is anticipated that alterations and modification thereof will become apparent to the skilled in the art. Therefore, it is intended that the following claims be interpreted as covering all such alterations and modifications as fall within the true spirit and scope of the disclosure.

Several examples will now be provided to further clarify various aspects of the present disclosure:

Example 1: A method comprising receiving an input knowledge graph (KG), encoding the input KG to receive a first set of node embeddings, compressing the input KG into an output KG, encoding the output KG to receive a second set of node embeddings, and training a model for KG compression using optimal transport based on a distance matrix between the first set of node embeddings and the second set of node embeddings.

Example 2: The limitations of Example 1, wherein the input KG and output KG are encoded using a relational graph convolutional network (R-GCN).

Example 3: The limitations of any of Examples 1-2, wherein the input KG is compressed into the output KG using a graph coarsening model trained to select top ranked nodes to be included in the output KG.

Example 4: The limitations of any of Examples 3, wherein the graph coarsening model utilizes algebraic multigrid (AMG).

Example 5: The limitations of any of Examples 3-4, wherein the graph coarsening model utilizes Attention Based Top-K Pooling.

Example 6: The limitations of any of Examples 1-5, wherein training the model for KG compression includes minimizing a Wasserstein distance.

Example 7: The limitations of any of Examples 1-6, wherein the method further comprises: receiving a new KG and compressing the new KG using the model trained for KG compression.

Example 8: A system comprising one or more processor and one or more computer-readable storage media collectively storing program instructions which, when executed by the processor, are configured to cause the processor to perform a method according to any of Examples 1-7.

Example 9: A computer program product comprising one or more computer readable storage media, and program instructions collectively stored on the one or more computer readable storage media, the program instructions comprising instructions configured to cause one or more processors to perform a method according to any one of Examples 1-7.

What is claimed is:

1. A method comprising:
receiving an input knowledge graph (KG);
encoding the input KG to receive a first set of node embeddings;
compressing the input KG into an output KG;
encoding the output KG to receive a second set of node embeddings; and
training a model for KG compression using optimal transport based on a distance matrix between the first set of node embeddings and the second set of node embeddings.

2. The method of claim 1, wherein the input KG and the output KG are encoded using a relational graph convolutional network (R-GCN).

3. The method of claim 1, wherein the input KG is compressed into the output KG using a graph coarsening model trained to select top ranked nodes to be included in the output KG.

4. The method of claim 3, wherein the graph coarsening model utilizes algebraic multigrid (AMG).

5. The method of claim 3, wherein the graph coarsening model utilizes Attention Based Top-K Pooling.

6. The method of claim 1, wherein training the model for KG compression includes minimizing a Wasserstein distance.

7. The method of claim 1, further comprising:
receiving a new KG; and
compressing the new KG using the model trained for KG compression.

8. A system comprising:
one or more processors; and
one or more computer-readable storage media storing program instructions which, when executed by the one or more processors, are configured to cause the one or more processors to perform a method comprising:
receiving an input knowledge graph (KG);
encoding the input KG to receive a first set of node embeddings;
compressing the input KG into an output KG;
encoding the output KG to receive a second set of node embeddings; and
training a model for KG compression using optimal transport based on a distance matrix between the first set of node embeddings and the second set of node embeddings.

9. The system of claim 8, wherein the input KG and the output KG are encoded using a relational graph convolutional network (R-GCN).

10. The system of claim 8, wherein the input KG is compressed into the output KG using a graph coarsening model trained to select top ranked nodes to be included in the output KG.

11. The system of claim 10, wherein the graph coarsening model utilizes algebraic multigrid (AMG).

12. The system of claim 10, wherein the graph coarsening model utilizes Attention Based Top-K Pooling.

13. The system of claim 8, wherein training the model for KG compression includes minimizing a Wasserstein distance.

14. The system of claim 8, wherein the method performed by the processor further comprises:
receiving a new KG; and
compressing the new KG using the model trained for KG compression.

15. A computer program product comprising one or more computer readable storage media, and program instructions collectively stored on the one or more computer readable storage media, the program instructions comprising instructions configured to cause one or more processors to perform a method comprising:
receiving an input knowledge graph (KG);
encoding the input KG to receive a first set of node embeddings;
compressing the input KG into an output KG;
encoding the output KG to receive a second set of node embeddings; and
training a model for KG compression using optimal transport based on a distance matrix between the first set of node embeddings and the second set of node embeddings.

16. The computer program product of claim 15, wherein the input KG and the output KG are encoded using a relational graph convolutional network (R-GCN).

17. The computer program product of claim 15, wherein the input KG is compressed into the output KG using a graph coarsening model trained to select top ranked nodes to be included in the output KG.

18. The computer program product of claim 17, wherein the graph coarsening model utilizes algebraic multigrid (AMG).

19. The computer program product of claim 15, wherein training the model for KG compression includes minimizing a Wasserstein distance.

20. The computer program product of claim 15, wherein the method performed by the processor further comprises:
receiving a new KG; and
compressing the new KG using the model trained for KG compression.
